(19) United States
(12) Patent Application Publication
(10) Pub. No.: US 2013/0097242 A1
(43) Pub. Date: Apr. 18, 2013

(54) MECHANISM FOR FACILITATING DYNAMIC AND CENTRALIZED MANAGEMENT OF CONTENT FOR MULTIPLE WEBPAGES AT SOCIAL NETWORKING SITES

(71) Applicant: JOSEPH SHELBY HUBICK, Vancouver (CA)

(72) Inventor: JOSEPH SHELBY HUBICK, Vancouver (CA)

(73) Assignee: Salesforce.com, inc., San Francisco, CA (US)

(21) Appl. No.: 13/552,489

(22) Filed: Jul. 18, 2012

Related U.S. Application Data
(60) Provisional application No. 61/546,783, filed on Oct. 13, 2011.

(51) Int. Cl. G06F 15/16

(52) U.S. Cl. 709/204

(57) ABSTRACT

In accordance with embodiments, there are provided mechanisms and methods for facilitating dynamic and centralized management of content for multiple webpages at social networking sites. In one embodiment and by way of example, a method includes receiving a request, at a first computing device, to generate a webpage within a social networking site, generating the webpage at the social networking site, and sharing webpage contents of one or more existing webpages at one or more social networking sites with the newly-generated webpage at the social networking site.

### CLAIM OF PRIORITY

This application claims the benefit of U.S. Provisional Patent Application No. 61/546,783, entitled “Systems and Methods for Creating a Website on a Social Network” by Shelby Hubick, filed Oct. 13, 2011 (Attorney Docket No. 8956P092Z), the entire contents of which are incorporated herein by reference and priority is claimed thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating dynamic and centralized management of content for multiple webpages at social networking sites.

### BACKGROUND

Building webpages within social networking websites (e.g., Facebook®, etc.) is a growing trend, but the conventional techniques for management of such webpages are complex and inefficient as well as lack uniformity.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing system employing a centralized content management mechanism according to one embodiment;

FIG. 2A illustrates a customized contents management mechanism according to one embodiment;

FIGS. 2B illustrates centralizing content management according to one embodiment;

FIG. 3A illustrates a screenshot that is used for centralized content management according to one embodiment;

FIG. 3B illustrates a screenshot for creating a Facebook tab page according to one embodiment;

FIG. 3C illustrates centralizing content management according to one embodiment;

FIG. 4 illustrates a method for centralized content management according to one embodiment; and

FIG. 5 illustrates a computer system according to one embodiment.

### DETAILED DESCRIPTION

Methods and systems are provided for facilitating dynamic and centralized management of content for multiple webpages at social networking sites. In one embodiment and by way of example, a method includes receiving a request, at a first computing device, to generate a webpage within a social networking site, generating the webpage at the social networking site, and sharing webpage contents of one or more existing webpages at one or more social networking sites with the newly-generated webpage at the social networking site.

Embodiments are described with reference to an embodiment in which techniques for facilitating management of data are implemented in a system having an application server providing a front end for an on-demand database service capable of supporting multiple tenants, embodiments are not limited to multi-tenant databases nor deployment on application servers. Embodiments may be practiced using other networking and/or database architectures without departing from the scope of the embodiments claimed.

Next, mechanisms and methods for facilitating dynamic and centralized management of content for multiple websites will be described with reference to example embodiments.

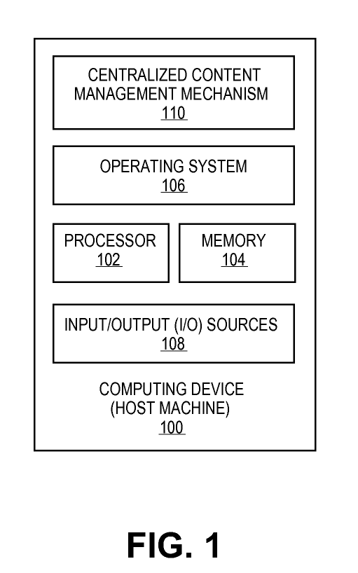

FIG. 1 illustrates a computing system employing a centralized content management mechanism according to one embodiment. In one embodiment, a computing device 100 serves as a host machine hosting a centralized content management mechanism (“centralized mechanism”) 110 to facilitate dynamic and centralized management of content, including sharing and synchronizing of content, between multiple independent websites and social network site-based webpages. Computing device 100 may include mobile computing devices, such as cellular phones including smartphones (e.g., iPhone®, BlackBerry®, etc.), handheld computing devices, personal digital assistants (PDAs), etc., tablet computers (e.g., iPad®, Samsung® Galaxy Tab®, etc.), laptop computers (e.g., notebooks, netbooks, ultrabook™, etc.), e-readers (e.g., Kindle®, Nook®, etc.), Global Positioning System (GPS)-based navigation systems, etc. Computing device 100 may also include server computers, desktop computers, cluster-based computers, set-top boxes (e.g., Internet-based cable television set-top boxes, etc.), and the like.

Computing device 100 includes an operating system (OS) 106 serving as an interface between any hardware or physical resources of the computing device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “client”, “client device”, “server”, “server device”, “machine”, “host machine”, “device”, “computing device”, “computer”, “computing system”, “multi-tenant on-demand data system”, and the like, may be used interchangeably throughout this document to illustrate various environments that may implement one or more aspects. It is to be further noted that terms like “application”, “software application”, “program”, “software program”, “package”, and “software package” may be used interchangeably throughout this document to illustrate various environments that may implement one or more aspects.

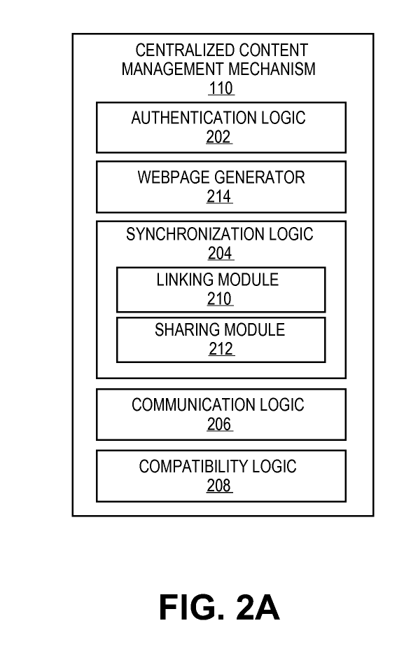

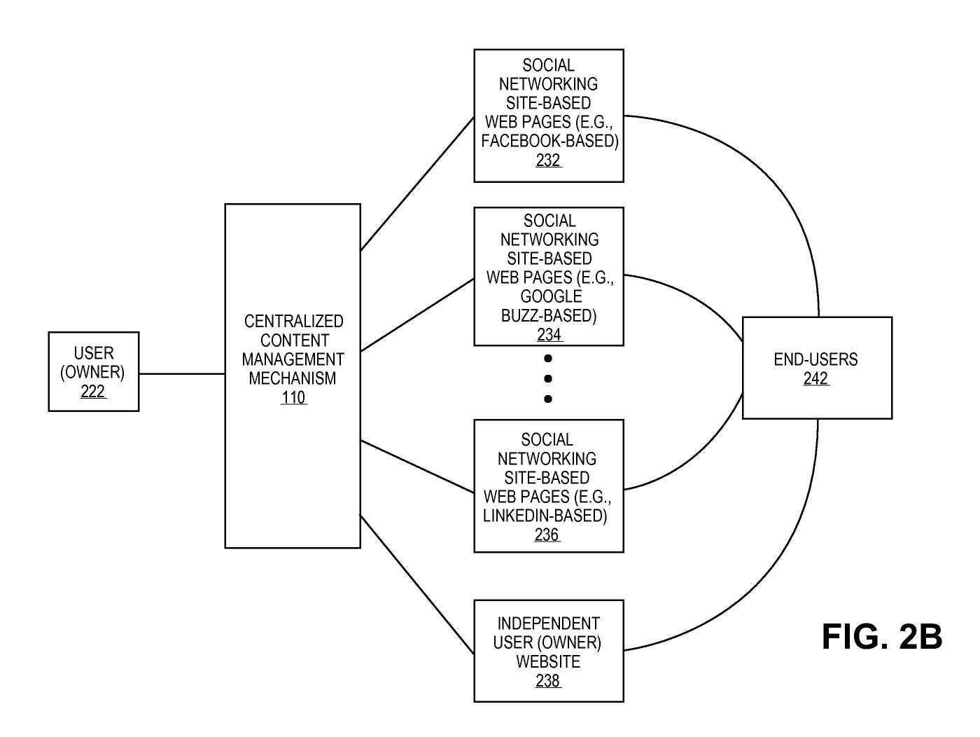

FIG. 2A illustrates a customized contents management mechanism according to one embodiment. In one embodiment, management of contents is facilitated using various components 202-214 of the customized mechanism 110 residing a computing device (e.g., a server computer, such as a cloud-based server computer, etc.), such as computing device 100 of FIG. 1 in a multi-tenant database system in an on-demand services environment. The term “webpage” may be interchangeably referred to as “fan page” or “tab page”. In one embodiment, content as referred to throughout this document may include, but is not limited to, independent website content, social networking site-based webpage content, user profile content, advertisement content, etc., while management of content or content management tasks may include, but is not limited to, integration, merging, synchronization, sharing, updating, adding, removing, modification, etc., of contents of multiple websites and/or webpages that may be unrelated to and independent of each other. It is to be noted that terms like “logic”, “component”, and “module” as referred to throughout this document may be used interchangeably include one or more of hardware, software, and firmware or any combination thereof.

In one embodiment, as will be further described with reference to FIG. 2B, authentication logic 202 provides authorization and authentication of users, social network sites (e.g., Facebook®, Google+®, LinkedIn®, etc.), computing devices, or the like, prior to initiating any content management tasks. Authentication logic 202 may employ and use any number and type of existing and/or future authentication and authorization techniques. Further, webpage generator 214 may be used to generate a webpage within a social networking website. Synchronization logic 204 provides for synchronization of contents using a mapping or linking technique through linking module 210 and sharing of contents using sharing module 212. Communication logic 206 facilitates bi-direction and multi-direction communication between various websites, webpages, social networking sites, computing devices, etc., over a network, such as a cloud computing network, an intranet, the Internet, wide area network (WAN), local area network (LAN), personal area network (PAN), metropolitan area network (MAN), etc. Compatibility logic 208 provides compatibility between centralized mechanism 110 and various existing, changing and/or future computing devices, social network sites, websites, webpages, protocols, standards, platforms, technologies, or the like.

It is contemplated that any number and type of components may be added to and/or removed from centralized mechanism 110 to facilitate various embodiments including adding, removing, and/or enhancing certain features. For brevity, clarity, and ease of understanding of the centralized mechanism 110 many of the standard and/or known components, such as those of a computing device, are not shown or discussed here. It is contemplated that embodiments are not limited to any particular technology, topology, system, architecture, and/or standard and are dynamic enough to adopt and adapt to any future changes.

FIG. 2B illustrates centralizing content management according to one embodiment. In one embodiment, centralized mechanism 110 may be hosted by a computing device, such as a cloud server computer, to manage contents of any number of social network site-based webpages 1-N 232-236 and, similarly, any number of independent websites, such as website 238. It is contemplated that webpages and websites 232-236, 238 may be access by end-users 242 from a single or multiple computers, including mobile computing devices (e.g., smartphones, tablet computers, laptop computers, etc.), desktop computers, server computers, etc., and similarly, user 222 may access centralized mechanism 110 using any number of computers, including mobile or non-mobile computing devices. These computing devices hosting centralized mechanism 110, webpages and websites 232-236, 238, and providing access to user 222 and end-users 242 may be similar to or the same as computing device 100 of FIG. 1. In the illustrated embodiment, user 222 may include an owner of webpages and websites 232-236, 238. An owner may include, but is not limited to, a business owner, a system administrator, a programmer, or any individual authorized to generate, maintain, modify, delete, etc., webpages/websites 232-236, 238 on behalf of an individual or an organization (e.g., a small business, a corporation, a government agency, an academic institution, a non-profit organization, etc.). End-users 242 include, but are not limited to, individuals (e.g., consumers) who may access webpages and websites 232-236, 238 via computing devices, but may not access centralized mechanism 110, such has without having the ability to generate, maintain, modify, delete, etc., webpages/websites 232-236, 238.

For example, user 222 owns an independent website 238 (such as a company website) that provides information about the company and the products and/or services it offers. Now, let us suppose, user 222 wishes to create a webpage 232 within a social networking site (e.g., Facebook) to, for example, further promote the business. In one embodiment, user 222 may access centralized content management mechanism 110, via a computing device, to generate a webpage 232 within social networking site. Authentication logic 202 authenticates the user 222 and extends authorization to access and use centralized mechanism 110 to generate the webpage 232. Once authenticated and authorized, the user 222 may provide or input the necessary information and/or request linking or mapping with the existing website 238 to generate the new webpage 232. In one embodiment, user 222 may explicitly request the linkage with website 238 and other existing webpages or set up an automatic linkage based on a predetermined criteria (e.g., periodic mapping, continuous mapping, event-based mapping (such as each time a new webpage is generated or an existing one is modified, etc.).

Upon receiving the request and the relevant information, webpage generator 214 facilitates generation of the webpage 232 at the first social network site. Once the webpage 232 is generated, synchronization logic 204 is triggered, upon request or automatically as aforementioned, to establish, via linking module 210, a link between the new webpage 232 and the existing website 238. Once the linkage or mapping is established, some or all of contents between the webpage 232 and the website 238 may be shared and synchronized via sharing module 212. Whether some or all of the contents is shared or synchronized may also be determined and set by the user 222. For example, all contents may be shared and synchronized so both the webpage 232 and the website 238 may provide the same content to the end-users 242.

Now, let us suppose, the user 222 wishes to generate additional webpages 234, 236 at other social network sites (e.g., Google+ and LinkedIn), the user 222 and centralized mechanism 110 may follow the similar processes as described with regard to generating the first webpage 232. For example and in one embodiment, once the new webpages 234, 236 are generated, contents of any two or more of the webpages 234-236 may be shared and/or synchronized and similarly, contents of website 238 may be shared and/or synchronized with one or more of the webpages 234-236.

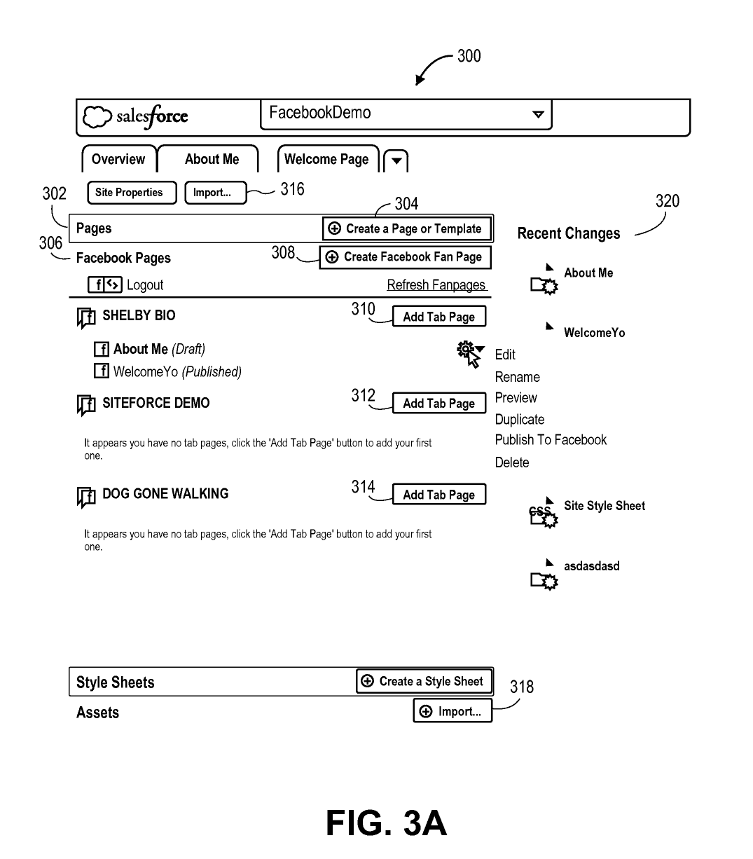

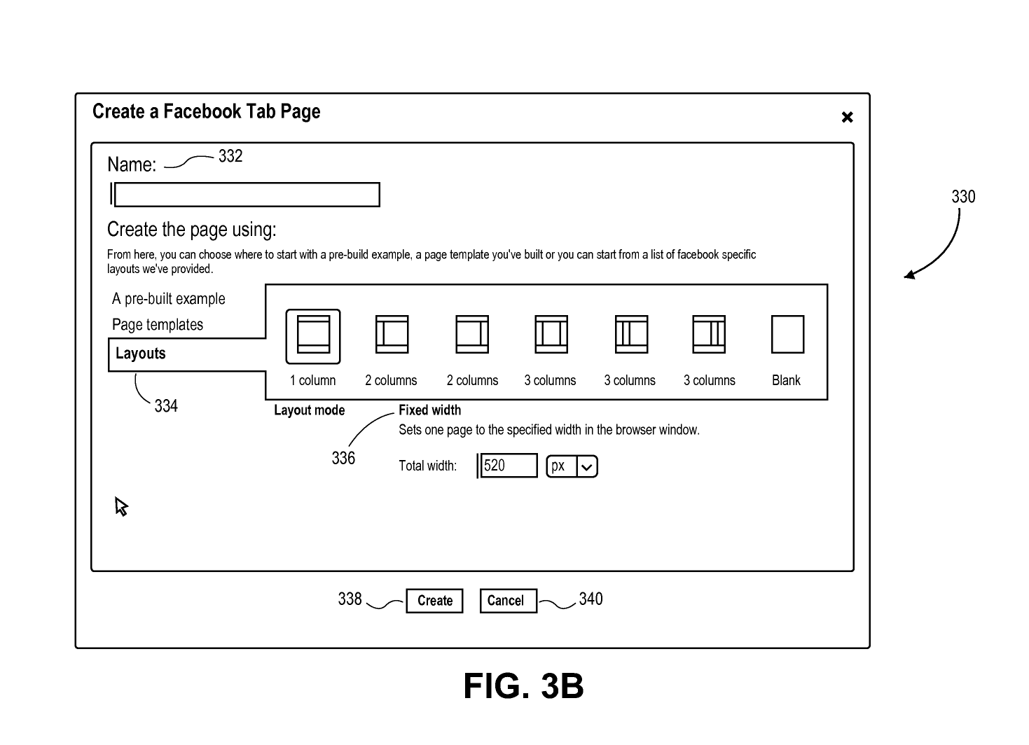

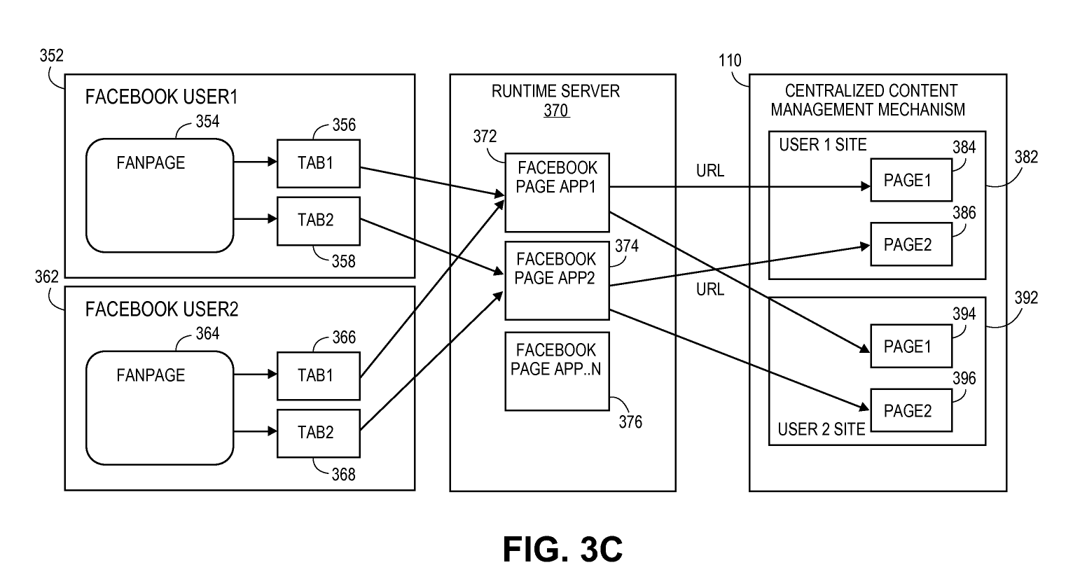

FIG. 3A illustrates a screenshot that is used for centralized content management according to one embodiment. The illustrated embodiments of FIGS. 3A, 3B and 3C use Facebook as an example, but it is contemplated that embodiments are not limited to a particular social networking site, such as Facebook, or any of the options provided here or the pattern and form of the screenshot 300 illustrated here. In the illustrated embodiment, screenshot 300 provides a list of options available for each webpage. For example, in case of Facebook, a user may be provided various options to create a generic page 302 by clicking Create a Page or Template 304, a Facebook page 306 by clicking Create a Facebook Fan Page 308, a tab page by clicking on Add Tab page 310-314, or the like. Screenshot 300 further provides options to import 316, 318 data, such as from an existing website or webpages or other sources of information, such as a database, etc. The right portion of the screenshot 300 provides a list of recent changes 320, such as edit, rename, preview, duplicate, publish to Facebook, delete, etc.

FIG. 3B illustrates a screenshot 330 for creating a Facebook tab page according to one embodiment. Screenshot 330 provides options to create a Facebook tab page, such as a space to provide a name 332 for the page, a set of page layouts 334, page width 336, etc., along with the options to create 338 and cancel 340 the page.

FIG. 3C illustrates centralizing content management according to one embodiment. Continuing with the Facebook example, in one embodiment, to publish a webpage on Facebook, a runtime server 370 may be published in association with and/or by centralized mechanism 110, such as using the same operation as the one used for publishing webpages. For example, a partial publish may be used to merely publish the page and the assets it references. In the illustrated embodiment, runtime server 370 provides or hosts Facebook page applications 1-N 372-376. Then, a new tab page may be created within Facebook and associated with the corresponding fan page. In one embodiment, using the user's credentials, a request may be placed (by centralized mechanism 110) with Facebook to have it create a new tab page. It may also be requested that the name may be changed to match the name of the page created within centralized mechanism 110 or the user may be redirected to Facebook's create tab page dialog to perform this operation.

Facebook user 1 352 may have a fan page 354 associated with tab 1 356 and tab 2 358 mapped with page application 1 372 and page application 2 374, respectively, at runtime server 370. The page applications 372 and 374 are further mapped to page 1 384, 394 and page 2 386, 396, respectively, of user 1 site 382 and user 2 site 392 at centralized mechanism 110. Facebook user 2 362 may have a fan page 364 associated with tab 1 366 and tab 2 368 mapped with page application 1 372 and page application 2 374, respectively, at runtime server 370. The page applications 372 and 374 are further mapped to page 1 384, 394 and page 2 386, 396, respectively, of user 1 site 382 and user 2 site 392 at centralized mechanism 110. This way, when a user accesses a page 354, 364 at Facebook, the centralized and synchronized information is provided via pages 384-386, 394-396 at user sites 382, 392 at centralized mechanism 110 through page applications 372, 374 at runtime server 370.

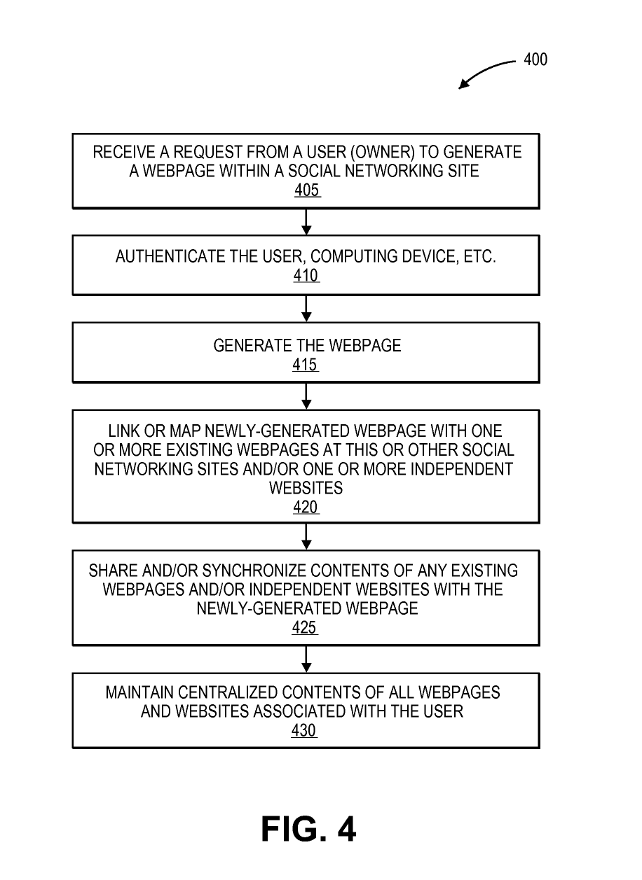

FIG. 4 illustrates a method for centralized content management according to one embodiment. Method 400 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 400 is performed by the centralized content management mechanism 110 of FIG. 1.

Method 400 begins at block 405 receiving a request at a first computing device from a user (owner), using a second computing device, to generate a webpage within a social networking site. At block 410, authentication and authorization of the user, the second computing device, the social networking site, etc., is performed. At block 415, a webpage is generated following the authentication/authorization process and in response to the request. At block 420, in one embodiment, the newly-generated webpage is linked or mapped to one or more existing webpages associated with the user at this or other social networking sites and/or further linked or mapped to one or more independent websites associated with or owned by the user. The aforementioned mapping or linking may be performed based on the user's request as set forth in the user request or as predetermined and provided through a user profile or specification.

At block 425, in one embodiment, once the liking or mapping is established, any or all contents of the newly-generated webpage and the existing webpages and/or websites is shared and synchronized. The shared/synchronized content for all webpages and websites associated with the user is then centrally managed. At block 430, the centralized content is maintained via the centralized content management mechanism 110 of FIG. 1 employed at the first computing device.

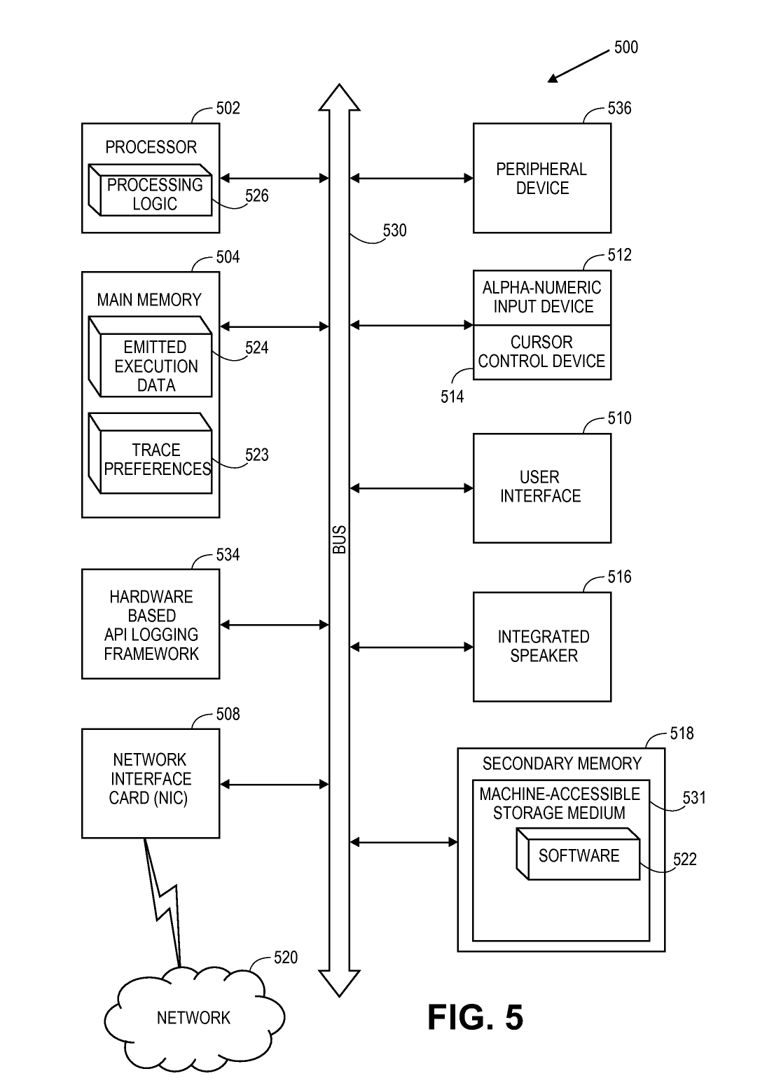

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing device 100 of FIG. 1. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of centralized mechanism 110 as described with reference to FIGS. 1 and 2 and other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of centralized mechanism 110 as described with reference to FIGS. 1 and 2 and other figures described herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

What is claimed is:

1. A computer-implemented method comprising:
receiving a request, at a first computing device, to generate a webpage within a social networking site;
generating the webpage at the social networking site; and
sharing webpage contents of one or more existing webpages at one or more social networking sites with the newly-generated webpage at the social networking site.

2. The computer-implemented method of claim 1, further comprising sharing website contents of one or more existing independent websites with the webpage at the social networking site.

3. The computer-implemented method of claim 1, further comprising centralizing the shared contents of the newly-generated webpage, the one or more webpages, and the one or more existing independent websites.

4. The computer-implemented method of claim 3, further comprising mapping the newly-generated webpage with the one or more existing webpages or the one or more existing websites, wherein mapping facilitates sharing of the contents and centralizing of the shared contents.

5. The computer-implemented method of claim 4, wherein the request is placed by a user via a second computing device including a mobile computing device, and wherein the first computing device includes a cloud-based server computer system coupled to the second computing device over a network including the Internet.

6. A system comprising:
a computing device having a memory to store instructions, and a processing device to execute the instructions, wherein the instructions cause the processing device to:
receive a request, at a first computing device, to generate a webpage within a social networking site;
generate the webpage at the social networking site; and
share webpage contents of one or more existing webpages at one or more social networking sites with the newly-generated webpage at the social networking site.

7. The system of claim 6, wherein the processing device is further to share website contents of one or more existing independent websites with the webpage at the social networking site.

8. The system of claim 6, wherein the processing device is further to centralize the shared contents of the newly-generated webpage, the one or more webpages, and the one or more existing independent websites.

9. The system of claim 8, wherein the processing device is further to map the newly-generated webpage with the one or more existing webpages or the one or more existing websites, wherein mapping facilitates sharing of the contents and centralizing of the shared contents.

10. The system of claim 9, wherein the request is placed by a user via a second computing device including a mobile computing device, and wherein the first computing device includes a cloud-based server computer system coupled to the second computing device over a network including the Internet.

11. A machine-readable medium having stored thereon instructions which, when executed by a machine, cause the machine to:
receive a request, at a first computing device, to generate a webpage within a social networking site;
generate the webpage at the social networking site; and
share webpage contents of one or more existing webpages at one or more social networking sites with the newly-generated webpage at the social networking site.

12. The machine-readable medium of claim 11, wherein the processing device is further to share website contents of one or more existing independent websites with the webpage at the social networking site.

13. The machine-readable medium of claim 11, wherein the processing device is further to centralize the shared contents of the newly-generated webpage, the one or more webpages, and the one or more existing independent websites.

14. The machine-readable medium of claim 13, wherein the processing device is further to map the newly-generated webpage with the one or more existing webpages or the one or more existing websites, wherein mapping facilitates sharing of the contents and centralizing of the shared contents.

15. The machine-readable medium of claim 14, wherein the request is placed by a user via a second computing device including a mobile computing device, and wherein the first computing device includes a cloud-based server computer system coupled to the second computing device over a network including the Internet.
